(19) United States
(12) Patent Application Publication
(10) Pub. No.: US 2014/0368956 A1
(43) Pub. Date: Dec. 18, 2014

(54) Apparatus, System, and/or Method for Intelligent Motor Protection and/or Control

(71) Applicants: Andre Pierre Perra, Portland, OR (US); Kent Jeffrey Holce, Portland, OR (US); Scott E. Leonard, Portland, OR (US)

(72) Inventors: Andre Pierre Perra, Portland, OR (US); Kent Jeffrey Holce, Portland, OR (US); Scott E. Leonard, Portland, OR (US)

(21) Appl. No.: 14/210,436

(22) Filed: Mar. 13, 2014

Related U.S. Application Data
(60) Provisional application No. 61/780,971, filed on Mar. 13, 2013.

(51) Int. Cl. H02H 7/08; H02H 3/38; H02H 1/00; H02H 3/26

(52) U.S. Cl. CPC H02H 7/08; H02H 3/26; H02H 3/38; H02H 1/0092
USPC 361/30; 702/58

(57) ABSTRACT

Improved motor starters and/or overload electronics are presented for industrial automation systems, HVAC systems, pumping systems, and/or similar implementations. Protective devices can be configured to offer substantially automatic control and/or protection for motors without first being manually calibrated, or properly calibrated, for the motor. An overload, motor starter, and/or other motor protection and/or control device can accommodate substantially universal voltage input, true power characteristic sensing for status output/annunciation, integrated damper control, and substantially automated protection and/or trip point selection and/or protective parameter calculation and implementation with reference to startup values and/or system parameters such as full load amperage (FLA), motor classification, motor horse power, monitored current, monitored voltage, and true power characteristics, including power factor values.

### RELATED APPLICATIONS

This application is a nonprovisional of, and claims the benefit of priority from, U.S. Provisional Patent Application No. 61/780,971, filed Mar. 13, 2013, entitled “Apparatus, System, and/or Method for Intelligent Motor Protection and/or Control”, which is hereby incorporated by reference in its entirety.

### COPYRIGHT NOTICE

© 2014 Franklin Control Systems, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d), (e).

### TECHNICAL FIELD

The present application is directed to the field of motor protection for industrial automation systems, HVAC systems, pumping systems, and similar implementations, and, in particular, to motor starters and related electronics offering substantially automatically available protection and/or control of such motors.

### BACKGROUND

In building automation systems, heating, ventilation, and air conditioning (HVAC) installations, pumping systems, and other industrial implementations, it is common to use starters or starter mechanisms to control and protect motors. Starters for motors and the like are generally well known in the art. Typical starters comprise thermal trip elements combined with contactors to disconnect a motor from line power in the event of an undesirable operating condition. In the United States, The National Electric Code (NEC) classifies combination starters as devices that provide thermal overload protection and motor disconnect functionality.

Key components of a traditional starter include an electromagnetic contactor and an overload relay. The circuitry of such traditional starters offers both motor control and motor protection functionality via a single device that is ideally specifically selected or calibrated for the particular motor being controlled. Operation of the motor (e.g., starting and stopping the motor, etc.) can be controlled through modulation of the contactor, which includes separable contacts that are electromechanically/electromagnetically operated by an energized or de-energized coil. Closing the contacts allows line power to energize the motor, while opening the contacts cuts of power from the motor.

As mentioned above, starters also are able to provide thermal protection (i.e., overload protection) to a motor to protect it against unfavorable operating conditions. Traditional starters typically include an overload relay provided for this purpose. Overload conditions occur when equipment is operated in an electrically undamaged circuit in excess of the normal full load current rating (e.g., the conductors carry current in excess of the rated amperage for the equipment or conductors). The overload is detected by the overload relay with reference to the applicable current trip point (expressed as a trip curve, which designates trip points as a function of current and time for a given motor classification). Overload conditions persisting for a sufficient amount of time can damage the motor, conductors, or other equipment. In the United States, and as used throughout this application, the terms “overload”, “overload protection” and “overload relay” are defined by the National Electrical Manufacturers Association (NEMA) standard ICS2, which is hereby incorporated by reference in its entirety. In the past, typical overload relays were implemented using heater/detector elements, such as using bimetallic relays or thermal heater elements. More recently, however, electronic overloads have been increasingly used. Electronic overloads may include a current transformer or other current sensor to detect and monitor current supplied to the motor.

For simple electromechanical motors, a traditional starter apparatus with control and overload protection functionality generally provides adequate motor protection if it is property calibrated to the specific motor it is protecting. Each classification of motor has its own applicable overload tolerances and operating parameters. Accordingly, starters that operate motors are required to employ overload relays and corresponding overload trip circuits that are specifically selected and calibrated in order to ensure that the proper level of thermal protection is afforded to the specific motor (or class of motor) being protected. Traditional calibration procedures require an installer to set a trip point manually by dialing one or more potentiometers on an electronic overload relay to a known parameter value, such as the full-load-amperage (“FLA”) rating of the motor, as specified on the motor nameplate and/or on system schematics.

The requirement for properly calibrated protective equipment can pose a problem in situations where several starters are shipped in bulk to an original equipment manufacturer (OEM), and the OEM ships numerous starters in bulk to a job site. Often, the starters arriving at the job site may not be marked or labeled. Installers frequently install the unlabeled starters inappropriately, and then attempt to start attached motors without ensuring proper calibration of the starter. Such procedures are dangerous and can result in damage to equipment, personal injury, or worse. A similar problem can develop if system demands or equipment change, such as when a fan or other equipment is added or ductwork is changed in an HVAC system, or when a motor or pump, etc. is added, removed, or changed out of an installation. Failure to ensure that the starter is, or remains, properly calibrated for the new load it is protecting and/or controlling can result in unintended and/or undesirable consequences.

### SUMMARY

While starters, overload relays, and/or other thermal or electronic protection devices are well known in the art, present embodiments provide novel and nonobvious improvements to solve problems Applicants have discovered with conventional product offerings and traditional installations. Present embodiments can provide integrated novel and nonobvious functionality, either as a stand-alone overload relay device, or consolidated into a unitary starter housing, thus offering improved protection with significant cost savings, facilitated installation/operation, and other advantages and/or improvements over conventional starters.

In particular, improved overloads and starters can be provided to offer enhanced and substantially automatically applied motor protection functionality, regardless of whether the overload or starter was initially calibrated or calibrated properly. Substantially automatic protection can be offered as embodied in a safety starter, smart starter, and/or other intelligent protective and/or control equipment consistent with the present application. Such a safety starter can be designed to protect and control the motor even if someone has not set up a trip point based on full load running current/amperage (FLA), or otherwise not calibrated the starter. Starters can be designed to protect the motor automatically against an overload condition by measuring, among other possible parameters, the starting current and power factor characteristics and comparing them to known acceptable and/or expected motor starting condition values. Measured parameters, such as inrush peak current and current measurements over time can be used, at least in part, to determine if the motor's running current falls (or stays) within one or more predefined ratios or ranges of acceptable current values. If so, then the motor can be assumed to be running properly. If the running current is outside of the predefined range, the starter can provide a fault and/or warning annunciation/message to indicate that it is out of calibration and needs to be recalibrated, and/or it can trip and a relay can cut off power to the motor, thus reducing the risk of equipment damage. An end user can be offered a jumper switch, programmable input, and/or other input interface to select if the starter will annunciate and/or trip if a problem is detected. Additionally, monitoring voltage values can facilitate present embodiments in determining and using true power values, such as power factor, to provide improved protection and/or control.

Electronic overload components or overload components integrated into smart starters, as described herein, can be configured to provide various advantageous motor-protection features including, without limitation, locked rotor protection, cycle fault protection, out-of-calibration protection, stall protection, and maximum start time protection, etc. This functionality can be built into and automatically available with overload relays and/or starters employing such overload devices. By installing a safety starter automatically offering such motor protection features, one can be substantially assured that the starter can offer at least an initial level of motor protection and control functionality on first start, regardless of whether the starter was calibrated or calibrated properly. Starters as disclosed herein can also substantially enable one or more motor-protection features as a substantially automatic, ongoing level of protection during motor operation. A suitable microcontroller and/or microcontroller-based control board can be used, along with suitable memory storage known in the art, such as programmable nonvolatile or substantially nonvolatile memory, at least in part, to monitor the specified parameters and initiate proper procedures for error handling, fault annunciation, and modulation of electronic components to protect the motor and/or related equipment.

Consistent with the present application, starter embodiments can also include additional and/or alternatively desirable functionality, depending on the given installation. For example, such functionality, embodied in an overload, motor starter, and/or other motor protection and/or control device can be configured to accommodate substantially universal voltage input, true power characteristic sensing for status output/annunciation, integrated damper control, and substantially automated trip point selection and/or protective parameter implementation based, at least in part, on startup or running values of current, voltage, power factor, and/or other values characteristic of a load, and which can be appropriately implemented consistent with applicable system parameters (e.g., full load amperage (FLA), motor classification, motor horse power, power factor values, etc.).

Additional aspects and advantages of this invention will be apparent from the following detailed description of preferred embodiments, which proceeds with reference to the accompanying drawings.

### BRIEF DESCRIPTION OF THE DRAWINGS

FIG. 1 illustrates one embodiment of a starter apparatus consistent with the claimed subject matter.

FIG. 2 illustrates one embodiment of a system schematic for a starter embodiment consistent with the claimed subject matter.

FIG. 3 depicts one embodiment of current-time graph illustrating protective characteristics consistent with the claimed subject matter.

FIG. 4 depicts one embodiment of a current and power factor graph for a motor startup time period consistent with one embodiment of the present subject matter.

### DETAILED DESCRIPTION

The following description discloses various embodiments and functionality associated with the starter apparatuses, systems, and methods for use, at least in part, in applications such as building automation, industrial systems automation, heating, ventilation, and air conditioning (HVAC) installations, and applications including the control and protection of motors and electro-mechanical devices driven by motors, such as pumps, fans, conveyor belts, etc., to name but a few illustrative examples of systems, presented for purposes of illustration and not by way of limitation.

In particular, the subject matter of the present application and the detailed starter embodiments described herein are preferably adapted for providing substantially automatic control and/or protection for motors regardless of whether the protective equipment was initially calibrated, or calibrated correctly. Those skilled in the art will appreciate that the advantageous functionality presently described can be embodied as a standalone overload apparatus embodiment (such as an electronic overload relay), or as a starter or combination starter embodiment including such overload protection as a component, along with the contactor and/or other starter components.

In one aspect, consistent with the present subject matter, starter functionality can be enabled, at least in part, through one or more embodiments of a starter control module (SCM) embodiment and related technology. One embodiment of a SCM can include components such as a meter base and a custom interface printed circuit board assembly to cooperatively facilitate motor control and/or protection. The specific electronics comprising the SCM can be further adapted, selected, and/or configured so as to facilitate optimization for an particular intended operating environment/application, such as to substantially represent an energy management starter (e.g., for HVAC implementations, etc.), a building automation starter (e.g., for industrial control applications, etc.), or an intelligent pump starter (e.g., for pump control applications, etc.). As used here, the term “starter control module” or “SCM” refers to the actual printed circuit board and related control board electronics and mechanical interfaces, rather than an entire integrated starter controller. For example, one SCM embodiment can be integrated into a single unitary enclosure along with an integrated overload relay and any required electromagnetic contactors to comprise a motor starter. However, a SCM embodiment can also be offered and/or employed modularly, such that it can be used as a standalone component to work with third-party supplied contactors, overload relays, and/or external current sensors, etc.

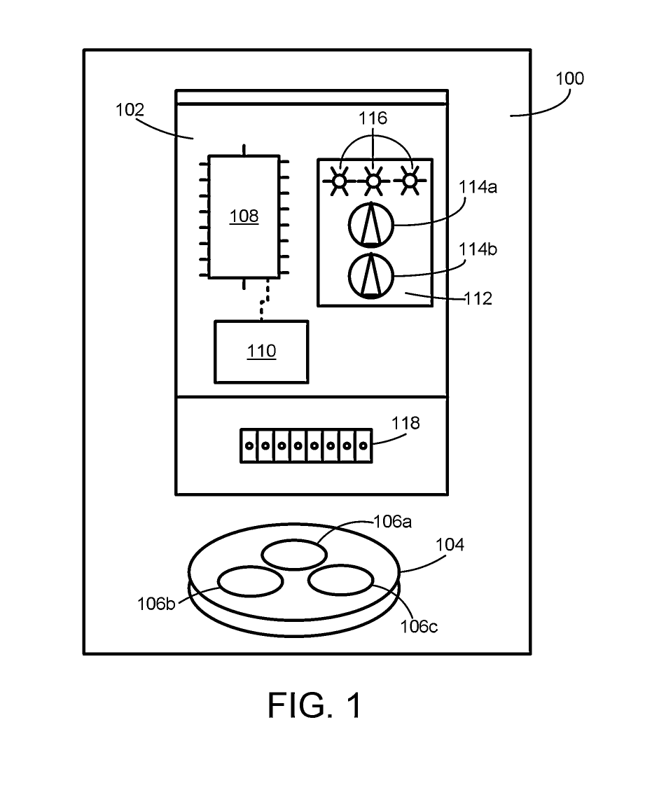

FIG. 1 presents a conceptual diagram illustrating one embodiment of a starter control module consistent with the present subject matter. With particular reference to FIG. 1, the starter control module 100 is depicted as including a control board 102 and a meter base 104. Meter base 104 of FIG. 1 includes three current sensor embodiments 106a through 106c. Control board 102 includes a microprocessor 108 functionally coupled with memory 110, which can include firmware instructions and/or programmable memory storage. Control board 102 also can include a user interface assembly 112. The user interface assembly embodiment 112 illustrated in FIG. 1 includes two user selectable switches 114a through 114b as well as pilot light indicators 116 suitable for indicating to the user the present operating mode of starter control module 100. Starter control module 100 is also depicted as having a terminal board 118, illustrating but one example of an input/output wiring interface. Those skilled in the art will readily appreciate that additional, alternative, or fewer components than those illustrated in FIG. 1 could also be employed consistent with the present subject matter.

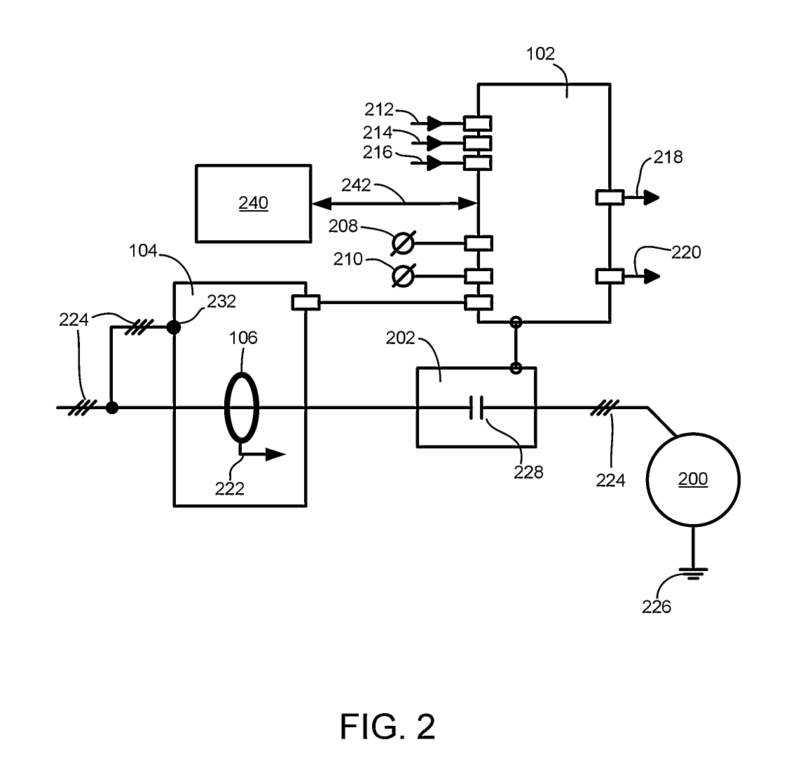

For further illustration, and to facilitate discussion, FIG. 2 illustrates a schematic of one starter embodiment, suitable, at least in part, for substantially implementing and/or embodying the present subject matter. A microprocessor-based printed circuit board for such a starter embodiment can employ unique customized firmware to, at least in part, provide the desired advantageous functionality. This can be embodied as a starter control board that can accommodate building automation control logic and communications. With particular reference to FIG. 2, a three-phase motor 200, such as a typical induction motor traditionally used in industrial applications, operates on three-phase power lines 224. The starter embodiment of FIG. 2 includes a control board 102 and a meter base 104 similar to those depicted in FIG. 1 and previously described. As illustrated in FIG. 2, the meter base 104 can include a current sensor 106 and/or voltage sensor 232. In one such embodiment, the current sensor 106 can be a current transformer monitoring line current (however, those skilled in the art will appreciate that alternative current sensing mechanisms could also be implemented consistent with the claimed subject matter, such as measuring current in shunt, as but one alternate example—although, if current is measured in shunt, current dividers and or other suitable electronic components may need to be implemented to step down the voltage to an appropriate level). Current sensor 106 can provide a current measurement signal, output voltage, or other output 222 suitable for metering and/or overload protection purposes. While FIG. 2 illustrates one current sensor 106, it is understood that current could be measured from one or more of the 3-phase power lines 224. The meter base 104 embodiment of FIG. 2 also depicts a voltage sensor 232 for monitoring line voltage. Similarly, voltage could be measured from one or more of the 3-phase power lines 224, according to known devices and/or methodology/electronic circuitry for monitoring and measuring voltage. For example, voltage could be measured by directly sampling it from the conductors, or current transformers could be employed to provide a proportionate induced voltage rating. Such embodiments can also be provisioned and/or configured to substantially accommodate wide-range power supply and wide-range voltage sensing. Line power voltage can also be employed as a power source for the control board 102 and/or a microprocessor or other circuit elements operating thereon, by employing a control power transformer, voltage converter, scaler, rectifier, or one or more other suitable devices or circuit elements advantageous for stepping down relatively high line voltage to the appropriate voltage range for powering circuit components (e.g., from 480 VAC to 24 VDC, etc.). Measuring both current and voltage also affords embodiments consistent with the present subject matter the ability to calculate true power consumption, which can offer distinct advantages for motor control and/or protection, as discussed in more detail below.

Continuing with the starter embodiment illustrated in FIG. 2, control board 102 can also include user interface controls, such as control switches 208, 210. Control switches 208, 210 can allow a user to select between operating the starter embodiment by hand commands, or commands driven from a remote controller, such as might be implemented in a building automation system. Accordingly, control board 102 can be configured for receiving multiple automated control inputs, such as an auto-low command 212 an auto-high command 214 and a shutdown command 216. Such commands could be interred, as one example from a Hand-Off-Auto (HOA) control interface as is commonly used in the arts. Suitable output signals can also be generated by control board 102, such as run status signal 218 or fault signal 220.

Consistent with the present subject matter, motor control board 102 can be employed to control and protect motor 200 via coordinated operation of contactor 202, including separable contacts 228. As illustrated in the starter embodiment of FIG. 2, an overload relay can include current transformer 106 depicted in meter base 104 to obtain current measurement 222 can facilitate providing overload protection to motor 200 via contactor 202. Control board 102 monitors the operating state and appropriately controls the contactor as instructed by way of input signals 212, 214, 216, and/or user interface switches 208, 210.

Continuing with FIG. 2, control board 102 can also include a status output relay to provide a run status signal 218 indication as a built-in feature. Such embodiments can use the same sensors for multiple aspects of alternative functionality. For example, current sensor 106 can be used to provide overload protection and a run status indication 218. The functionality of such embodiments can include auto-sensing for status annunciation based on the monitored current 222 being at least a pre-specified percentage of full-load amperage (FLA).

In applications such as HVAC control and protection, if an undesirable situation happened, such as a belt breaking, and the current correspondingly drops, status output can be provided to indicate the condition. This can happen with or without a corresponding trip command being given, as desired.

Control board 102 can also offer energy management functionality. Monitored current 222 via current sensor 106 and voltage via voltage sensor 232 can substantially allow for power metering at meter base 104. Because voltage can be monitored via voltage sensor 232, run status indications 222 can also be based on true power (not just current). By monitoring both voltage and current a truer sense of power to the load can be achieved. This allows for tighter tolerances more precise control and can do a better job in detecting undesirable occurrences such as belt loss on a motor drive, etc. For an additional advantageous aspect, one or more starter embodiments can employ manual and/or substantially self-calibrating overloads to provide both status indications and overload protection in a combined device, which can be combined with a contactor as well. The functionality of such embodiments can also include auto sensing for status annunciation based on the monitored current 222 being at least a pre-specified percentage of full-load amperage (FLA), for implementation in proof-of-flow or loss-of-flow/belt-loss monitoring, etc. The FLA can be initially provided to control board 102, obtained as a lookup value from operating memory 240 for each motor winding, and/or automatically determined via a self-calibrating overload circuit/relay, to illustrate but a few examples.

Memory storage 240 can be available to control board 102 as any of several programmable nonvolatile or other suitable memory devices. Memory storage 240 can be provisioned integral to the control board 102 or accessed via a communication link to a remote storage location. Memory link 242 indicates that memory may be accessed by control board 102, as well as data written to memory storage 240. Those skilled in the relevant art will appreciate the advantages such a system architecture would provide. In particular, and consistent with the methodologies illustrated in more detail below, memory storage 240 can be pre-populated with one or more lookup tables, databases, and/or other storage embodiments substantially suitable for providing appropriate known and/or empirically determined electronic device protection and/or control parameters (e.g., such as thermal inverse trip curve values, etc.) to the control board for reference when implementing a control and/or protection methodology as indicated below. Such embodiments can allow for convenient lookup of known appropriate control parameter values for a known or identified motor being, or to be, protected and/or controlled. Similarly, one or more present embodiments are also capable of contextual learning from values sensed, calculated, and/or determined for one or more motors being controlled and/or protected within the system. Newly obtained data can also be written to memory storage 240 such that the data set is built out over time to include more robust or broader coverage, as well as to substantially facilitate the system in more finely tuning and/or tailoring its control and/or protection methodology to the specific environment and/or application in which it is being operated (e.g., to substantially appropriately protect and/or control the specific type, size, efficiency, and/or class of motor or motors coupled to the system).

As previously mentioned, electronic overload devices (e.g., overload protection relays, etc.) and starter embodiments as described herein are preferably adapted for providing substantially automatic protection for motors regardless of whether the protective equipment was initially calibrated, or calibrated correctly. Those skilled in the art will appreciate that the advantageous functionality presently described can be embodied as a standalone overload protection device (such as an electronic overload relay), or as a starter or combination starter embodiment including such overload protection as a component. Motor-protection features including, without limitation, locked rotor protection, cycle fault protection, out-of-calibration protection, stall protection, and maximum start time protection, etc., can be enabled, at least in part, through cooperation between hardware, software, and/or firmware components of embodiments as described herein. The methodologies, heuristics, and procedures embodiments can use to detect and protect against each expected and/or potential fault condition can be programmed directly into firmware and/or into machine-executable instructions (e.g., represented, at a high-level, by the state machine procedures and/or logic disclosed in more detail below) stored in memory on or accessible by a microprocessor-based control board, or other suitable location within the relevant electronics. Monitoring the input current, voltage, the current response over time, as well as calculated true power characteristics such as power factor, as well as being provided with a FLA setting, known or determined for purposes of overload protection, present embodiments can automatically provide the desired additional levels of motor protection and/or control by executing the stored instructions.

In order to, at least in part, enable the protective functionality described herein, overload protection devices and/or starters (hereinafter “protection and control equipment”), can monitor current and voltage applied to the motor during startup and/or operation. Current transformers or other current sensing components of the protection and control equipment can be used to monitor the current. Voltage sensors may similarly be employed. The monitored current, voltage, and/or calculated power values can then be compared to known, expected characteristics for the particular motor being controlled/protected. For example, a motor classified as a trip-class 10 motor will exhibit certain expected current and/or power characteristics at startup and displayed over time in a proper operating condition. Similarly, expected and/or potential fault conditions will display varying current response characteristics and/or power factor response characteristics that are substantially consistent, and thus identifiable, for motors of that classification. Similarly, trip-class 20 motors also substantially exhibit consistent current and power characteristic behavior and/or response characteristics depending on the operating conditions affecting the motor.

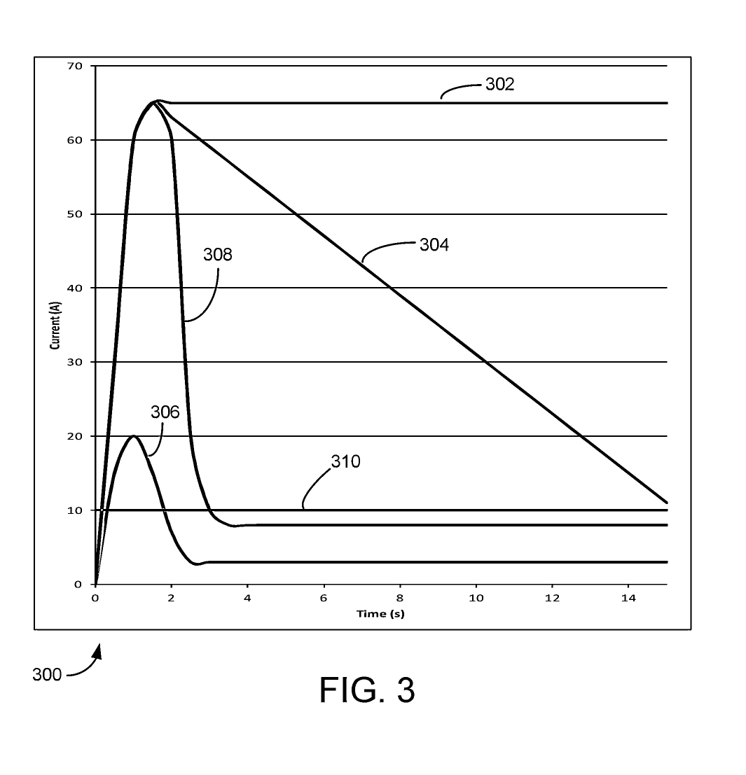

FIG. 3 illustrates one example of a current-time graph plotting current versus time characteristics for normal motor operation, and illustrative examples of characteristic current responses to various potential fault conditions as well as incorrectly calibrated motor operation. With particular reference to FIG. 3, time is plotted on the horizontal axis and current is plotted on the vertical axis of graph 300. The various current responses illustrated over time in graph 300 illustrate examples representing a motor normal start condition 308, as well as a locked rotor condition 302, a maximum-time fault condition 304, and an out-of-calibration condition 306. These various current responses are illustrated with reference to a to full load amperage (FLA) value 310.

With particular reference to FIG. 3, the protection methodology can begin when an installer or motor operator provides (or inadvertently omits to provide) a set FLA value, such as FLA value 310, illustrated in FIG. 3 as being 10A. The supplied FLA value is typically obtained from the motor nameplate, system schematic diagrams, and/or other convenient and easily ascertainable sources. The FLA value is provided to motor overload protective equipment as part of a proper calibration procedure. However, if the FLA value is not provided to present embodiments, or is provided as indicating a value inconsistent with the actual FLA of the motor being controlled/protected, the automatic protection functionality of the present embodiments will still protect the motor. The undesirable operating conditions are detected and avoided, at least in part by comparing one or more of starting current, in rush/peak current, running current over time, and the indicated or set-point FLA value, and comparing the relationship between one or more of these parameters to the corresponding expected responses indicative of proper or improper operating conditions for the motor.

To illustrate this concept with reference to FIG. 3, normal current response characteristics are depicted as response 308. As can be seen with response 308, the initial current on startup quickly spikes from zero to a peak value (illustrated here as approximately 65 A) before rapidly dropping back down to a running current value under FLA value 310. This in-rush spike is indicative of startup conditions for inductive motors. For example, it has been empirically determined that, typically, the majority of induction motors exhibit and inrush current spike of approximately 6 to 12 times the FLA value. However, with the introduction of more high-efficiency motors, the inrush spike range representative of most motors can be more inclusively indicated as 5 to 13 times FLA. In other words, normal operating run current typically falls between 1/13 and ⅕ of the inrush current. To properly accommodate the expected inrush current upon starting a motor, overload protection devices employ standard inverse trip curves commonly known for various motor classifications. These trip curves indicate the appropriate overload protection time response to avoid damaging the motor and/or conductors with excess current supplied for prolonged periods of time. For example, an inverse trip curve will indicate how long a motor should be maintained at a particular current value before an overload protection device trips. If, however, the current does not drop off appropriately after the inrush spike, or if the running current does not achieve and maintain a level within an acceptable range, then presently disclosed embodiments will automatically detect such occurrence as indicating a fault condition and/or requirement for calibration.

Continuing with specific reference to FIG. 3, one example of a current response for a locked rotor 302 is illustrated. With a locked rotor condition, the current essentially remains at or near its inrush peak value, or does not drop off after the inrush peak. If the circuit's current monitoring components detect this condition for a predefined unacceptable amount of time, such as three seconds, as but one example, a locked rotor fault can be given, which can be indicated through an alarm, signal annunciation, or a trip. Of course, the three second time. Example is purely for illustrative purposes and not meant by way of limitation. Other time periods, such as two seconds, or longer or shorter periods, could also be employed consistent with the present subject matter.

One example of the maximum-time-to-start fault 304 is also illustrated in FIG. 3, and can be characterized by the current steadily dropping after the peak inrush value, but not dropping quickly enough to be indicative of normal operating characteristics 308. If the monitored ongoing current, even though dropping, does not drop off rapidly enough to enter a defined safe operating window (e.g. between 1/13 and ⅕ of the measured peak value, as but one example) within a predetermined amount of time, such as the 10 seconds of startup overload condition allowed for a trip-class 10 motor (or 20 seconds for a trip-class 20 motor), the maximum-time-to-start fault can be indicated, and handled via fault annunciation, tripping, or other suitable response. Regardless of the FLA setting or i²t curve, present embodiments can still automatically protect the motor against potentially damaging overload conditions. With a maximum-time-to-start fault 304, the current may not be high enough to result in an instantaneous trip of an overload protection device, but they current may still be maintained for too long at a potentially damaging level, and thus present embodiments will detect and protect against this situation.

One example of an out-of-calibration fault 306 is also illustrated in FIG. 3. This condition could exist, as but one example, if an equipment installer omits calibration for or indicates a inaccurately high FLA value in order to try and avoid an overload trip (for example, if having already experienced one overload trip, and seeking to avoid the nuisance of restarting the system in the event of other overload trips, the installer intentionally indicates a higher than actual FLA setting). Regardless of the inappropriately indicated FLA setting, present embodiments can detect that the motor is not operating within acceptable operating range. If the ratio of run current to start current is outside of a predefined acceptable range, present embodiments can alarm and/or trip, or provide a suitable indication that the equipment requires calibration or recalibration. Current response 306 represents an incorrect calibration, in that the inrush spike (illustrated in FIG. 3 as 20A) is not between 5 to 13 times the indicated FLA of 10 A. This is detected, through present embodiments, by measuring the actual inrush and dividing by, as one example, the outer ranges of the expected inrush multiplier over FLA. For example, as presently illustrated, if the inrush current is expected to be between 5 to 13 times the FLA, dividing the measured inrush peak current by five, and comparing it to the measured running current, out-of-calibration faults can be detected. In other words, normal running current should be between 1/13 and ⅕ of the peak current value. In the example illustrated in FIG. 3, having a measured peak inrush value of 20A, the FLA value should be between 4A (i.e., 20A/5) and 1.54A (i.e., 20A/13). However, because the indicated FLA of is 10A, it is outside of this acceptable expected range, and an out of calibration fault is determined to exist. Accordingly, regardless of an intentionally or accidentally incorrect FLA value being supplied, present embodiments will still function appropriately to protect the motor and/or detect the discrepancy and signal for proper calibration to be performed. Additionally, alternative embodiments, as disclosed in more detail below, can automatically calculate and/or employ a corrected calibration parameter using, at least in part, the measured current values.

Those skilled in the art will also appreciate that additional, and/or alternative protective functionality can be employed using embodiments configured as described herein. For example, similar to locked rotor fault protection, stall protection can be afforded to motors through present embodiments. In a stall condition, even if occurring after the startup mode of the motor has completed, the current would be expected to spike outside of the normal acceptable operating range and remain at and/or near the spiked value (i.e., remain outside of the normal acceptable operating range). As such, present embodiments can substantially help ensure that motors operate within a safe operating range, whether at startup, or subsequently during operation. Other levels of protection, such as cycle fault protection can also be provided consistent with present embodiments. For cycle fault protection, a starter embodiment, or an overload relay embodiment cooperatively working with a starter control board that operates a contactor supplying current to the motor, the number of contactor start signals being detected can indicate a cycle fault. For example, if the contactor is being operated at a rate of over 1200 starts per hour, a cycle fault can be indicated through fault indication and/or a trip.

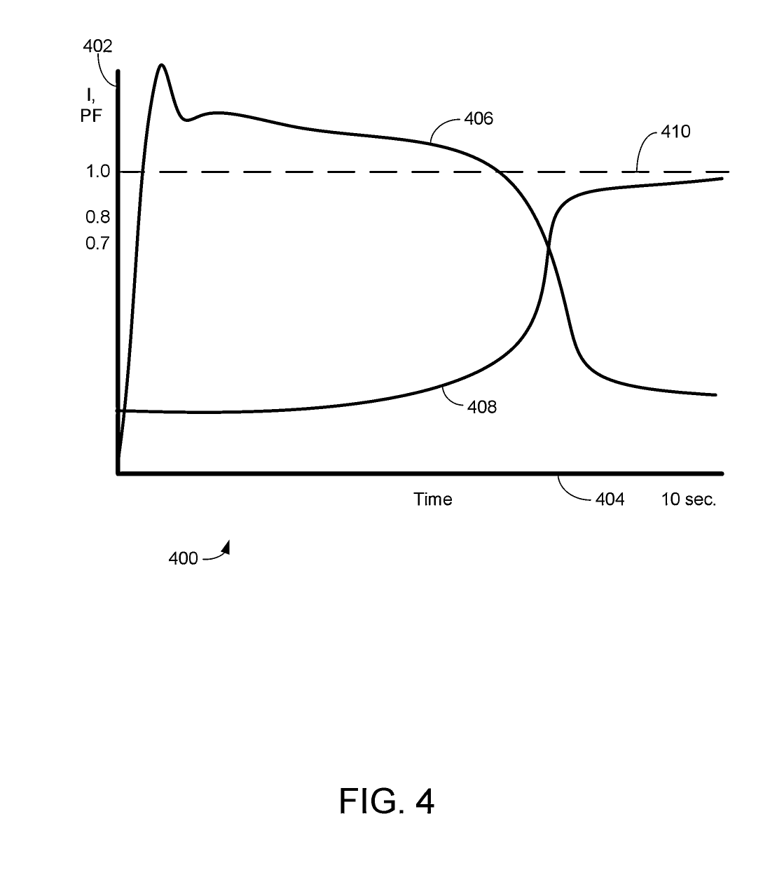

Additionally, those skilled in the relevant art will appreciate that by sensing voltage, in addition to current, more useful information regarding true power can be obtained and implemented consistent with the present methodologies. For example, FIG. 4 depicts one embodiment of a graph conceptually illustrating the relationship of current to power factor over time during an initial startup time period for a motor. With particular reference to FIG. 4, graph 400 graphs current and power factor on the y-axis 402 against time on the x-axis 404. A current response curve 406 is depicted along with a power factor curve 408. As can be seen in graph 400, the power factor curve 408 approaches the value of one 410 as time progresses.

The behavior of the current and power factor graphs in FIG. 4 can provide advantageous information for detecting faults, such as a locked rotor or stall condition, as but two examples. The power factor of an AC power distribution system is determined as the ratio of real or true power flowing to a load (e.g., such as an induction motor, etc.) to the apparent power of the circuit. It is represented as a dimensionless value between −1 and 1. It can be calculated as the RMS value of current times voltage, compared to an instantaneous RMS value of current times an instantaneous RMS value for voltage.

Those skilled in the relevant art will readily appreciate that present embodiments can substantially provide for a broad array of motor protection and/or control methodologies. By measuring voltage, in addition to current, and employing true power characteristics, such as power factor, additional advantageous functionality can be substantially enabled and/or facilitated. While the prior disclosed embodiment simply monitored current to provide motor protection functionality, using current values alone does not provide as full of a representation of the motor performance as does using true power. In particular, calculating monitoring the response of the power factor graph 408 over time provides a more complete picture of the motor performance, which can be advantageous for fault detection. For example, at startup, the current value might stay near its peak inrush value. By only considering current one would expect that the motor is in a locked rotor condition. However, there may be other factors involved, and the current may be appropriately high, given these other factors. However, if the power factor does not increase or approach 1.0, a locked rotor condition can be concluded. Similarly, if after a motor has been operating, the current increases with the power factor decreases, a stall condition can be concluded.

In order to implement the protective functionality discussed above, present embodiments can include a control board with a microprocessor executing programmable instructions implemented in firmware, or via other suitable programming and memory, to implement the current and voltage sampling, conduct power factor calculations, compare the results to expected values, and implement the appropriate protection and/or control functionality in response. In order to facilitate discussion, and not by way of limitation, the protection and control functionality discussed above is illustrated in the following sections as one or more software subroutines comprising or implementing more motor protection state machine embodiments.

The first example set forth below represents one illustrative embodiment of a state machine for a safety start embodiment using current monitoring, consistent with the present subject matter. Such embodiment can offer a baseline level of protection as described above. However, the second illustrative example set forth below monitors both current and voltage, and indicates additional protection and/or control methodologies that can be substantially enabled and/or facilitated by employing true power characteristics, such as the power factor of the system. Additionally, the second illustrative example below illustrates one exemplary embodiment of a state machine for a safety calibration embodiment. As indicated in the second illustrative example, more robust, precise, and finely tuned protection and/or control methodologies can be advantageously employed. Of course, those skilled in the art will readily appreciate that fewer, additional, and/or alternative state machine components could be employed, compared to those indicated in the two illustrative examples below, without departing from the scope of the present subject matter.

A first illustrative embodiment can be described as a “safety starter” embodiment. Subject matter consistent with the present application can be provided as a safety starter. Such a safety starter can be designed to protect the motor even if someone has not set up the trip point based on full load running current/amperage (FLA). It can be designed to protect the motor in the event of an overload or other undesirable condition based, at least in part, on the starting current characteristics. For example, it can measure the inrush current and then determine if the motor's running current falls within a predefined ratio or range of values. If so, then operation is considered to be running properly. If the running current is outside the range, the starter can indicate that it is out of calibration and needs to be recalibrated, and/or it can trip. A PCB jumper selector can be provided to allow an end user to select if the starter will annunciate or trip if a problem is detected.

Such embodiments can be advantageous in situations in which several starters are shipped in bulk to an OEM and the OEM ships in bulk to job sites where the starters may not be marked or labeled and installers install them and start motors without calibrating the starter. In such situations, the safety starter will still protect the motor. Once it has been calibrated, the safety starter embodiment can operate substantially similarly to other known starters or other novel starters consistent with the present application.

Electronic overload components in starters can provide various types of protection: e.g., stall protection, locked rotor fault, etc. Preferably, this functionality can be built into starters with electronic overloads. The safety starter can facilitate the offering of such motor protection features and work on first start regardless of whether calibration has been performed or performed correctly. It will be able to detect and appropriately annunciate or trip if the motor has a locked rotor, is in stall, or if the current is still decreasing and hasn't reached running current in the maximum time allowed at startup per motor class (e.g., 10 seconds for class 10 motor, or 20 seconds for class 20 motor, etc.). As used herein, the term “Max start” refers to the maximum time to let the system operate in a starting condition. For example, it typically takes 3-4 seconds to drop from inrush peak current to running current, especially for a fan, because fans have substantially constant loads. If the current is still decreasing after the maximum allowed time for allowing the motor to start (e.g., 10 seconds for class 10, 20 seconds for class 20, etc.), the safety starter will react. Also, once it's running, if the motor is running outside of a predefined “safe range” the safety starter can be programmed to annunciate and/or after a set period of time, trip.

The following sections details a first illustrative embodiment of firmware subroutines and programming logic representing a machine state code embodiment consistent with one embodiment of a safety starter, such as the one described above.

Summary of Safety Start Code Embodiment

This subroutine below schedules all subroutines that run in the low level priority Interrupt Service Routine (ISR), including those listed.

sched low isr

If 5ms interrupt
call mpr_state_machine

This following subroutine contains the Motor Protection State Machine which allows the program to transition thru the necessary startup states to determine if a starter's FLA is out of an acceptable calibration range. The Motor Protection state is also used by other subroutines to make the decision on when to run. This subroutine is called at the completion of every 5 ms. The Motor Protection State is global.

mpr state machine

```
      State 1: WAIT_RUN_CMD_STATE
            If valid run command
                  Enter State 2
      State 2: WAIT_CUR_ABOVE_0_STATE (inductive kick should happen
here)
            If run not commanded
                  Enter State 1
            Else if Proof of Flow (current > .5A) on any one phase
                  If Safety Start is enabled
                        Enter State 3
                  Else
                        Enter State 7
            Else if waiting for POF > 2 minutes
                  Set Damper/Contactor alarm
      State 3: PROCESS_START_CONDITION_STATE
            If run not commanded
                  Enter State 1
            Else
                  Accumulate up to 4 starting current samples and save these and
                  sample count to use later
                  Store current in rotating buffer
                  If Locked Rotor Condition (no change in current for 3 seconds)
                        Set Locked Rotor Fault
                        Enter State 6
                  Else if Max Start Time Condition (TRIP CLASS (10,20...60)
                  seconds have elapsed since POF)
                        Set Max Start Time Fault
                        Enter State 6
                  Else if Start Condition in progress (current slope > −2)
                        Remain in State 3
                  Else if Operating Speed Reached (current slope < −2)
                        Enter State 4
                  Else if this unexpected condition happens 3 times in a row
                        Set Safety Start Fault
                        Enter State 6
      State 4: PROCESS_OPERATING_SPEED_STATE
            If run not commanded
                  Enter State 1
            Else
                  Store current in rotating buffer
                  If Stall (current above 300% of set FLA and current not
                  decreasing for .5 seconds)
                        Set Stall Fault
                        Enter State 6
                  Else if Max Start Time Condition (TRIP CLASS (10,20...60)
                  seconds have elapsed since POF)
                        Set Max Time Fault
                        Enter State 6
                  Else if Cycle Fault (Contactor is closed at a pre-selected,
                  specified closures/hour)
                        Set Cycle Fault
                        Enter State 6
                  Else if Operating Speed State in progress: (current slope > .05)
                        Remain in State 4
                  Else if Steady Speed Reached: (− .05<current slope<.05)
                        Enter State 5
                  Else if this unexpected condition happens 3 times in a row
                        Set Safety Start Fault
                        Enter State 6
      State 5: PROCESS_STEADY_STATE
            If run not commanded
                  Enter State 1
            Else
                  LRC = accumulated LRC / samples (4 or less),
                  [where LRC is Locked Rotor Current]
                  Store Run Current
                  Log most recent of 3 logged start conditions consisting of:
                        FLA Setting
                        Locked Rotor Current (LRC)
                        Time to Start
                        Run Current
                  Enter State 7
      State 6: WAIT_FAULT_RESET_STATE
            If Fault has been reset or if run not commanded
                  Enter State 1
      State 7: RUNNING_STATE
            If run not commanded
                  Enter State 1
            Else if FLA OUT OF CALIBRATION (If run current within an acceptable
            range of LRC)
                  If FLA OUT OF CALIBRATION FAULT enabled
                        Set FLA OUT OF CALIBRATION Fault
                        Enter State 6
                  Else
                        Set FLA OUT OF CALIBRATION Alarm
            Else if Stall (current above 300% of FLA and current not decreasing by
            .5 seconds)
                  Set Stall Fault
                  Enter State 6
            Else if Cycle Fault (Contactor is closed at a specified closures/hour)
                  Set Cycle Fault
                  Enter State 6
```

The preceding description provides one illustrative example, describing information for one or more safety starter embodiments consistent with the present application. Of course, the information and example embodiments described within this application are presented for illustrative purposes only. They are not meant or intended to limit the scope of the present subject matter to the specific embodiments presented. Those skilled in the relevant art will appreciate that additional, fewer, or alternative embodiments could also be employed consistent with the present application. Thus, the scope of the present application should only be limited by the claims made thereto.

The following description provides a second illustrative example, which represents a “Safety Calibration” embodiment. The following section details a machine state code embodiment consistent with one such safety calibration embodiment, providing protection and control functionality such as described above.

Summary of Safety Calibration Code Embodiment

The following sample subroutine can schedule other subroutines that run in the low level priority Interrupt Service Routine (ISR), including those specifically listed listed.

sched low isr

```
If 5ms interrupt
      If cycle (128 samples) complete
            call mpr_state_machine
```

For sampling purposes, embodiments can measure instantaneous current and voltage, and use these to calculate a power factor value. In one such illustrative embodiment three math operations occur. First, square current measurement and accumulate for current RMS calculation (Irms). Second, square voltage measurement and accumulate for voltage RMS calculation (Vrms). Third, multiply current measurement by voltage measurement and accumulate for power RMS calculation (Prms)

Once a full cycle is complete (128 samples for example), RMS calculations can be completed from accumulated data. Power factor can be calculated using real power divided by apparent power (Prms/(Irms*Vrms)). RMS values and power factor calculation can then be used in the disclosed motor protection state machine determinations to identify and select appropriate protective behavior.

The following example subroutine contains the Motor Protection State Machine which allows the program to transition thru the necessary states to calculate a valid Safety Calibration FLA to be used for motor protection. The Motor Protection state is also used by other subroutines to make the decision on when to run. This subroutine is called at the completion of every cycle (128 samples). The Motor Protection State can be global. Cycle Fault protection as well as many other protective features can take place in all states.

mpr state machine

```
      State 1: WAIT_RUN_CMD_STATE
            If valid run command
                  Enter State 2
      State 2: WAIT_CUR_ABOVE_0_STATE (inductive kick should happen
here)
            If run not commanded
                  Enter State 1
            Else if Proof of Flow (current > .5A) on any one phase
                  If Safety Calibration in progress
                        Enter State 3
                  Else
                        Enter State 7
            Else if waiting for POF > 2 minutes
                  Set Damper/Contactor alarm
      State 3: PROCESS_START_CONDITION_STATE
            If run not commanded
                  Enter State 1
            Else
                  Accumulate up to 4 starting current and PF samples and save
                  these and sample count to use later
                  Store current and PF in rotating buffer
                  If Locked Rotor Condition (Current above 300% of FLA and
                  current not decreasing and PF not changing for .5 seconds)
                        Set Locked Rotor Fault
                        Enter State 6
                  Else if Safety Cal Overload Condition (TRIP CLASS (10,20...60)
                  seconds have elapsed since POF) (i.e., Max Start Fault)
                        Set Safety Cal Overload Fault
                        Enter State 6
                  Else if Start Condition State in progress: (−.05 < current slope
                  <0) and (0 < pf slope < .05) (i.e. current slope is constant or
                  slightly negative and pf slope is constant or slightly positive)
                        Remain in State 3
                  Else if Operating Speed Reached: (current slope < −2)
                        Enter State 4
                  Else if this unexpected condition happens 3 times in a row
                        Set Safety Calibration Fault
                        Enter State 6
      State 4: PROCESS_OPERATING_SPEED_STATE
            If run not commanded
                  Enter State 1
            Else
                  Store current and PF in rotating buffer
                  If Locked Rotor Condition (current above 300% of FLA and
                  current not decreasing and PF not changing for .5 seconds)
                        Set Locked Rotor Fault
                        Enter State 6
                  Else if Safety Cal Overload Condition (TRIP CLASS (10,20...60)
                  seconds have elapsed since POF)
                        Set Safety Cal Overload Fault
                        Enter State 6
                  Else if Operating Speed State in progress: (current slope <−.05)
                        Enter State 4
                  Else if Steady Speed Reached: (− .05<current slope<.05 and −
            .05<pf slope<.05)
                        Enter State 5
                  Else if this unexpected condition happens 3 times in a row
                        Set Safety Cal Fault
                        Enter State 6
      State 5: PROCESS_STEADY_STATE
            If run not commanded
                  Enter State 1
            Else
                  LRC = accumulated LRC / samples (4 or less)
                  PF = accumulated PF / samples (4 or less)
```

[The averaging (over 4 or less samples, etc., as but one embodiment) can facilitate filtering of noise to make sure the substantially accurate appropriate value is determined without being undesirably affected by any noise]
Index into FLA Trip Multiplier table to locate K based indexed by LRC
CALIB_FLA=LRC/K

Lookup Table Embodiment 1

| Locked Rotor Current (LRC) | Locked Rotor Multiplier (K) |
|---|---|
| 1-36 | 13 |
| 37-75 | 10 |
| >75 | 9 |

Log to Non-volatile memory:

```
                  CALIB_FLA
                  LRC
                  LR MULT (the LR Multiplier value (K))
            Safety Calibration = not in progress
            Enter State 7
State 6: WAIT_FOR_FAULT_RESET_STATE
      If Fault has been reset or if run not commanded
            Enter State 1
State 7: RUNNING_STATE
      If run not commanded
            Enter State 1
      Else
              Perform Normal Motor Protection Monitoring
            If Safety Calibration Enabled
                  Use CALIB_FLA instead of FLA in calculations
      * * *
```

The preceding description provides one illustrative example, describing information for one or more safety starter embodiments consistent with the present application. Of course, the information and example embodiments described within this application are presented for illustrative purposes only. They are not meant or intended to limit the scope of the present subject matter to the specific embodiments presented. Those skilled in the relevant art will appreciate that additional, fewer, or alternative embodiments could also be employed consistent with the present application. Thus, the scope of the present application should only be limited by the claims made thereto.

For example, as opposed to Lookup Table Embodiment 1 disclosed above, an alternate lookup table could be referenced, such as, as but one alternative embodiment, the following table. In either instance, the locked rotor multiplier K can be empirically determined, or obtained from manufacturers data available for various motor classifications and/or sizes.

Lookup Table Embodiment 2

| FLA Range @ 480 V | Locked Rotor Multiplier (K) |
|---|---|
| 0 < FLA < 30 | 13 |
| 30 < FLA < 36 | 12 |
| 36 < FLA < 45 | 9.5 |
| 45 < FLA < 70 | 8 |
| FLA > 70 | 7 |

Similarly, additional embodiments may have additional, fewer, or alternative states to those depicted in the preceding embodiments. For example, rather than a machine state embodiment being configured to have a consolidated fault state, such as “Wait_For_Fault_Reset_State” for any monitored fault being detected, a machine state embodiment could accommodate separate, discrete states for different types of faults, such as a state such as “Wait_For_Locked_Rotor_Fault_Reset_State”, or state such as “Wait_For_Safety_Cal_Overload_Fault_Reset_State” etc. Such embodiments may, at least in part, allow for executable firmware programming instructions to apply more specifically tailored fault handling or status annunciation depending on the type of fault encountered.

As the disclosure contained herein is presented for illustrative purposes, and by way facilitating discussion, it will be obvious to those having skill in the art that many changes may be made to the details of the above-described embodiments without departing from the underlying principles of the invention. The scope of the present invention should, therefore, be determined only with reference to the following claims.

1. A system for protecting a load, comprising:
a current sensor for measuring current to a load;
a voltage sensor for measuring voltage to the load;
a relay configured for implementing a protective action in response to a fault condition being detected; and
a control board having a memory storage and a microprocessor,
wherein, the microprocessor is configured to execute programmable instructions to:
determine a power factor value from the measured current and the measured voltage;
monitor current change and power factor change over time;
compare the monitored current change and the monitored power factor change to corresponding expected values indicating a normal operating condition for the load; and
in response to an unfavorable comparison, signaling the relay to implement the protective action.

2. The system of claim 1, further comprising a contactor for controllably connecting power to the load.

3. The system of claim 2, wherein, in response to the unfavorable comparison, the relay signals the contactor to disconnect power to the load.

4. The system of claim 1, wherein the protective action includes fault annunciation.

5. The system of claim 1, wherein the fault condition is chosen from a group including: a locked rotor fault, a stall fault, an overload fault, and exceeded maximum time to start fault, a cycle fault, and an out of calibration fault.

6. The system of claim 5, wherein, in response to an out of calibration fault being detected, the microprocessor is further configured to initiate automatic recalibration of the relay.

7. An apparatus for motor protection and control, comprising:
a current sensor provisioned for sampling a plurality of current values over time;
a voltage sensor provisioned for sampling a plurality of voltage values over time;
a microprocessor including executable programming instructions to:
employ the plurality of current values and the plurality of voltage values to calculate a plurality of power factor values over time; and
monitor the current values over time and the power values over time to detect one or more fault conditions.

8. The apparatus of claim 7, wherein the one or more fault conditions are selected from a group including: a locked rotor fault, a stall fault, an overload fault, and exceeded maximum time to start fault, a cycle fault, and an out of calibration fault.

9. The apparatus of claim 8, wherein, in response to the microprocessor detecting an out of calibration fault for a motor protection device, the microprocessor is further configured to calculate a corrected calibration value for the motor protection device.

10. A method for protection and control of a load, the method comprising;
measuring current and voltage to a load;
using the measured current and voltage, calculating a power factor for the load;
monitoring the measured current and calculated power factor over time; and
in response to the monitoring indicating an undesirable operating condition, initiating a protective action for the load.

11. The method of claim 10, wherein the protective action includes signaling a protective relay to trip.

12. The method of claim 10, wherein the protective action includes annunciating a fault condition.

13. The method of claim 12, wherein the fault condition is one of: a locked rotor fault, a stall fault, an overload fault, and exceeded maximum time to start fault, a cycle fault, and an out of calibration fault.

14. The method of claim 13 further including, in response to an out of calibration fault, calculating a corrected calibration value.

15. The method of claim 14 further including automatically implementing the corrected calibration value.

16. The method of claim 14 wherein the corrected calibration value is a full load amperage value for the load.
